(19) United States
(12) Patent Application Publication
(10) Pub. No.: US 2016/0246294 A1
(43) Pub. Date: Aug. 25, 2016

(54) System for Flexible Operation of an Automated Plant

(71) Applicant: ENDRESS+HAUSER GMBH+CO. KG, Maulburg (DE)

(72) Inventors: Romuald Girardey, Blotzheim (DE); Gunter Jahl, Gerlingen (DE); Harald Freimark, Lorrach (DE); Stefan Robl, Hunxe (DE)

(21) Appl. No.: 15/027,494

(22) PCT Filed: Sep. 15, 2014
(86) PCT No.: PCT/EP2014/069588

§ 371 Date: Apr. 6, 2016

(30) Foreign Application Priority Data
Oct. 7, 2013 (DE) 10 2013 111 052.5

(51) Int. Cl. G05B 19/418

(52) U.S. Cl. CPC G05B 19/41845; G05B 2219/32019; G05B 2219/42155

(57) ABSTRACT

A system for flexible operation of an automated plant, comprising at least one computer and a plurality of field devices for determining and/or monitoring physical or chemical, process variables. The computer and the field devices are embodied to be network capable and are connected, with one another via a network. A unique address in the network is associated, with each computer and each field device and communication occurs via a defined network protocol. Associated with the network capable computer is at least one plant model, which virtually maps plant topology, plant function and interaction of the field devices with one another and with the computer, wherein the plant model is so embodied that it is adapatable flexibly to different plant topologies, different plant functions and/or different interaction of the field devices with one another and with the computer, and wherein the computer controls via the plant model the automated plant corresponding to current plant topology, current plant function and/or current interaction of the field devices with one another and with the computer.

The invention relates to a system for flexible operation of an automated plant of automation technology.

In process, as well as in manufacturing, automation technology, field devices are often applied, which serve for registering and/or influencing process variables. Serving for registering process variables are measuring devices, such as, for example, fill level measuring devices, flow measuring devices, pressure- and temperature measuring devices, pH measuring devices, conductivity measuring devices, etc., which register the corresponding process variables, fill level, flow, pressure, temperature, pH value and conductivity, respectively. Used for influencing process variables are actuators, such as valves or pumps, via which e.g. the flow of a liquid in a pipeline or the fill level of a medium in a container is changed. In connection with the invention, the terminology ‘field device’ includes, thus, all types of measuring devices and actuators.

Referred to as field devices in connection with the invention are, moreover, also all devices, which are applied near to the process and deliver, or process, process relevant information. Besides the earlier mentioned measuring devices/sensors and actuators, referred to as a field devices are generally also such units, which are connected directly to a fieldbus and serve for communication with the superordinated unit, thus units such as e.g. remote I/Os, gateways, linking devices and wireless adapters, respectively radio adapters. A large number of such field devices are manufactured and sold by the Endress+Hauser group of companies.

In modern automated plants, communication between at least one control unit arranged at the control level and field devices occurs, as a rule, via at least one bus system, such as, for example, a ProfiBus®, Foundation Fieldbus® or HART® bus system. The bus systems can be embodied both via wire as well as also wirelessly. The at least one superordinated control unit serves for process control, for process visualizing, for process monitoring as well as for start-up and servicing of the field devices and is also referred to as a configuration/management system. At the field plane, the field devices are connected with at least one PLC. Often, a number of PLCs are connected together in a series circuit. Known automation systems are hierarchically constructed and have a static structure.

A disadvantage of a static, respectively fixed, wiring is that there is no flexibility in the structure and in the data exchange. Accessing of field devices is only indirectly possible, since the field devices are usually fixedly connected together. The at least one PLC forms a central “node point” and represents, thus, a single point of failure. This can significantly limit the availability of the automated plant.

An object of the invention is to configure a system of an automated plant flexibly.

The object is achieved by a system comprising at least one computer and a plurality of field devices for determining and/or monitoring physical or chemical process variables, wherein the at least one computer and the field devices are embodied to be network capable and connected, respectively connectable, with one another via a network, wherein a unique address in the network is associated, respectively associable, with each computer and each field device and wherein communication occurs via a defined network protocol, wherein associated with the network capable computer, respectively the network capable computers, is at least one plant model, which virtually maps plant topology, plant function and interaction of field devices with one another and with the at least one computer, wherein the plant model is so embodied that it is adapatable flexibly to different plant topologies, different plant functions and/or different interaction of the field devices with one another and with the at least one computer, and wherein the at least one computer controls via the plant model the automated plant corresponding to current plant topology, current plant function and/or current interaction of the field devices with one another and with the at least one computer.

All field devices (actuators, sensors) are directly connected, respectively connectable, via a network (e.g. TCP/IP, WLAN, Ethercat, Ethernet/IP, Modbus TCP, ProfiNET, . . . ) with at least one computer arranged in the cloud. Each of the field devices has a unique address and is so equipped that it understands the network protocol. The terminology “cloud” means in connection with the invention a usually redundant network of computers, which operates via an internal or external network and a standard IT infrastructure. The system of the invention offers increased safety and flexibility as regards hardware failure.

Field devices connected with the computers of the cloud can transmit data, respectively measured values, generated by them either automatically and cyclically, or the field devices deliver the data, respectively measured values, to the computers via a classical request/reply communication via polling.

The plant system of the invention is mapped virtualized via a plant model in the cloud. The plant model corresponds to the plant structure and the plant function and defines the interaction of the field devices. The plant model is a software model, which is executed in the cloud. A plant is planned based on a model and is executed as a software model.

The cloud provides calculational services and memory capacity for executing the plant model.

Each model of the plant possesses, in given cases, also other properties. Thus, the plant functionality and the interconnection, respectively the interaction, of the individual field devices can be varied within broad limits. In this way, the plant can be optimized and adapted to changed requirements at the plant and in the plant. For example, adaptations can reflect changes of product characteristics or the amount of product output. Furthermore, an adapting to changed energy costs during different times of day can be performed, failed plant parts can be replaced by, in given cases, on-hand, redundant plant parts of equal value, etc. In the case of a change of the plant model, it is, in given cases, necessary to parameter the field devices anew.

The invention permits essentially easier scaling of the automated plant, i.e. the plant can be expanded by additional field devices, since the plant topology is independent of the underlying network structure. This is not possible in the state of the art, since only a defined, maximum number of field devices can be connected to a control unit. If this maximum number is exceeded, an additional control unit must be applied.

The processing capacity of the computers in the cloud can likewise be expanded practically as much as desired without restructuring measures in the plant and, thus, matched to growing requirements.

The complete context of the plant, i.e. all connected sensors, actuators, their interconnection and functionality, is accessible at all times without limitation and known, since the plant is embodied hierarchically flatly—other than in the case of hierarchically designed plants—.

The solution of the invention offers a number of advantages compared with a known, static solution:
By means of the solution of the invention, it is possible to adapt an automated plant to different processes running in a plant, since the system of the invention can be adapted simply and flexibly to the respective case of application.
The plant can be adapted optimally relative to energy consumption, waste reduction, respectively yield, and relative to the rate, with which a process is running in the plant. For example, it is possible to utilize the cheaper cost of electrical power in the nighttime by increasing the production rate in the nighttime. The terminology, process, means, moreover, all processes established in industry, e.g. manufacturing processes, fermentation processes, bottling processes, etc.
The solution of the invention is in high measure safe against failure.
a) If a measuring device fails, then the corresponding measured value is obtained from an alternative, equal valued source. For example, in the case of failure of a temperature sensor, the plant structure is so altered that an alternative temperature sensor of another measuring system, e.g. a pH-sensor or a flow sensor, located in the plant delivers the needed measured values of temperature.
b) If a plant partially fails, then its function can be assumed by a redundant, plant part.
Since e.g. a measured value is delivered from different, equal valued, measuring devices, it is possible to perform advanced diagnostics in the plant.
The plant possesses a high variability. Especially, it is possible to manufacture different products in the plant, e.g. a product A and a product B, since the system can be adapted to the manufacturing processes of different products.
The plant can, at any time, be scaled, respectively expanded, by adding new field devices and by increasing the resources of the computer network.

An advantageous embodiment of the system of the invention provides a number of computers, thus a computer network, wherein the computers are embodied redundantly and/or diversely and wherein the computers work redundantly or in combination with one another.

Moreover, an option is to operate a diverse and/or redundant signal processing in the cloud. Especially, e.g. two separate signal processings of a field device can be performed in the cloud. Alternatively, one signal processing can be executed by an intelligent field device and an additional diverse signal processing can be executed in the cloud.

The outputs of the two redundant and/or diverse signal processings are then compared by means of a decider. In the case of a significant deviation, a failure report is generated. According to the invention, any safety standard can be implemented in an automated plant.

Redundancy means increased safety through doubled or multiple layout of all safety relevant hardware and software components. Diversity means that the hardware components responsible for measured value processing, such as e.g. a microprocessor, come from different manufacturers and/or that they are of different type. In the case of software components, diversity requires that the software stored in the computers comes from different sources, e.g from different manufacturers, respectively different programmers.

In an advantageous further development of the system of the invention, it is provided that for the case, in which in the automated plant e.g. a production process or a bottling process is running, the at least one computer so controls the production rate by adapting the current plant functions and/or the current interaction of the field devices with one another and with the at least one computer such that the energy consumption of the automated plant is optimized.

In combination or alternatively, it is provided that for the case, in which in the automated plant is running a production process, the at least one computer so controls the production process that yield of the produced products is maximum and/or that the amount of occurring waste products is minimum. With both of the above embodiments, the productivity of an automated plant can be optimized.

With reference to predictive maintenance and advanced diagnostics, thus the generating of supplemental information, e.g. lifetime of the field device, from diagnostic data, the at least one computer detects based on the diagnostic data malfunctions and/or predictable or actual loss of defective field devices. Furthermore, in the case of detecting a malfunction, the computer transfers the plant function of the malfunctioning or lost field device to at least one redundant field device, which is likewise available to the system and which is able to perform the plant function of the malfunctioning or lost field device.

Moreover, a display is provided on the field device or on an external service tool, via which the field device is maintained, especially adjusted, calibrated or verified, or a mobile service tool is provided, which maintains, especially adjusts, calibrates or verifies the field device via the at least one computer. There are different options for maintaining field devices. The terminology, maintain, means in this context either adjusting (e.g. correcting the calibration factor), calibrating (ascertaining the measurement deviation) or verifying (checking the device function). The cloud can without problem be expanded by at least one diagnostic functionality. Preferably, all available diagnostic data of the sensors/actuators are supplied to the computers of the cloud, whereby it is possible to process the diagnostic data in the total context of the plant. In the case of the known systems for operating an automated plant, the diagnostic data must be defined and processed via a separate, condition-monitoring system.

In a first variant, the device is maintained on-site, locally, via a display or a service tool and, thus, without connection to the cloud.

In a second variant, e.g. via a mobile end device (e.g. a smart phone, a laptop or a tablet), for example, calibration is implemented via the connection to the cloud. In such case, the cloud in a first case is used as connection to the field device; the calibration routines then run in the field device. In a second case the complete calibration algorithm, including, in given cases, the associated menu guidance, runs completely in the cloud—and, indeed, automatically or upon request.

Especially advantageous in connection with the invention is when the at least one computer during the course of production performs at least one verification phase and stores information concerning the verified course of production in at least one memory unit associated with the computer/the computers. Since the plant via the plant model stored in the cloud possesses knowledge of the total production process, and, indeed, both concerning products to be produced as well as also what happens when in the process, it is possible in the course of production to initiate an automatic verification phase. The corresponding reports can be managed in the cloud. Preferably, they are transmitted to the cloud based on polling by the cloud.

A high degree of availability of the system of the invention can be achieved, when associated with the network capable computer, respectively the network capable computers, are a plurality of plant models, which virtually describe plant topology, plant function and interaction of the field devices with one another and with the at least one computer for different automated plants and/or production processes, and wherein the computer, respectively the computers, so controls/control the production plant that a selected plant model is used and the corresponding production process can run in the automated plant.

Moreover, the invention relates to a system, in the case of which field device-specific or field device type-specific drivers for the individual field devices are provided, wherein the at least one computer so parameters the field devices via the drivers that they are applicable in the production process and/or in the automated plant corresponding to the selected plant model. Preferably, firmware and/or device drivers of the individual field devices are associated with the at least one computer.

Furthermore, it is provided that an electronics is associated with each of the field devices, wherein the electronics is embodied either as a minimum electronics, which provides the raw data of the field devices—for example, thus, electrical signals, which include information concerning the process variable—or the electronics is embodied as an evaluating electronics and provides conditioned and/or evaluated data. For the case, in which the electronics is a minimum electronics, the at least one computer does the conditioning and/or evaluation of the provided data. The “intelligence” of the field devices is shifted into the cloud, and the evaluation of the data occurs in the cloud.

If the field device is a field device with an analog current output, then a coupler is provided, which makes the field device network capable.

In general, an option is to convert a classical PLC-based plant system successively into a cloud-based system of the invention by replacing parts of the classically implemented plant by network-based field devices.

For the case, in which the electronics is an evaluating electronics, the intelligent field device is able to transmit the raw data available in the field device and the conditioned and/or evaluated data to the at least one computer, wherein the computer conditions and/or evaluates the raw data and compares the provided conditioned and/or evaluated data with the data conditioned and/or evaluated by the computer. There is, thus, the opportunity to verify the data transmitted from the field device into the cloud.

As already mentioned, used as field devices can be classical field devices, which include the complete signal processing. In general, such field devices are referred to as intelligent (SMART) sensors, respectively actuators. Examples of such include Coriolis- and pH-transmitters.

The signal processing of field devices can, however, be shifted in the case of the system of the invention also without problem into the cloud. The field device, e.g. a sensor, concerns itself, in this case, only with the coupling to the analog world, while the digital signal processing no longer takes place in the field device, but, instead, in the cloud. In this way, e.g. improved diagnostic and measurement algorithms can be used, which previously were not possible because of size limitations in the firmware in the field devices. The previously extremely time-consuming and complicated firmware updates of the field devices can be implemented by a central update of the software in the cloud. The hardware complexity and therewith the price of the field devices can thereby likewise be reduced. By updating the field device algorithms in the cloud, additionally an update during operation of a field device can be implemented. In such case, a temporary parallel operation of old and new algorithms is performed. As soon as the new algorithms have e.g. in the case of a sensor achieved a stable measurement operation, the settling processes are thus ended, a switching from the old algorithms to the new can be performed, without necessitating an interruption of measurement operation.

In a preferred embodiment of the system of the invention, it is provided that firmware and/or device drivers of the individual field devices in at least two different versions, a first version and a successor version, are/is associated with the at least one computer, and that the at least one computer replaces the first version during operation of the automated plant with the successor version, as a soon as the successor version works faultlessly.

Furthermore, it is provided that the plant model, respectively the plant models, is/are constructed modularly and that in the case of a number of computers the modularly embodied plant model, respectively the plant models, are divided among the individual computers. In an embodiment, e.g. the software structure of the cloud is modularized. In this way, the cloud software infrastructure can be distributed to the available hardware and changes, especially expansions, can be fitted into the hardware resources. Modularity provides the opportunity of replacing individual software components of the cloud during operation, without having to interrupt normal operation of the plant. The same holds for the field device drivers. In order to be able to service the multiplicity of field devices, it is necessary—when a web server is not present—to provide a library, respectively a database, of drivers, e.g. DTMs.

An advantageous further development of the system of the invention provides that the plant model, respectively the plant models, is/are developed on a test system and tested with virtual field device models and that the developed plant model is copied, respectively transmitted, to at least one analog automated plant after the test phase.

If a plant operator has a plurality of physically identical plants, then an option is to develop and optimize the plant model on one plant, respectively on a test plant and then by a “copying procedure” to transmit the plant model to the identical plants. In this way, a marked simplifying of plant startup and plant maintenance can be achieved.

Moreover, it is provided that a test plant with virtual field device models is developed, simulated and tested. A plant model developed in this way is then transmitted to a real plant by means of “copy and paste”. Findings from the practical operation of the plant are then transferred to the simulation, optimized there and brought back to the real operation of the plant. Thus, an iterative optimizing process is performed. Additionally, in this way, worst-case scenarios based on the real plant model can be checked and improved.

Especially, there is the opportunity to copy, respectively to transmit, a tested plant model, respectively tested plant models, of an automated plant to identical automated plants.

In an advantageous further development, the system of the invention is integrated into an internal company network. For the case, in which communication is at least partially via an external, freely accessible network, the communication occurs preferably via a VPN tunnel structure. In order to assure access safety, an operator-internal, local cloud is preferred. Via VPN tunnel structures, the tunnel structure can be expanded, so that also spatially very extended plants can be implemented. Examples include e.g. gas pipelines, wind parks, water distribution networks, etc.

Especially favorable in connection with the invention is when a web server is integrated at least in a part of the field devices and when the servicing of the field devices occurs via the computer or via a mobile operating, or servicing, tool. In this way, the field device can be serviced by its own device driver manufactured specially for its servicing. Of course, in the case of a field device without web server, the servicing can alternatively occur via a usual device driver.

The invention will now be explained in greater detail based on the appended drawing, the figures of which show as follows:

FIG. 1 a schematic representation of a system known from the state of the art for operating an automated plant,

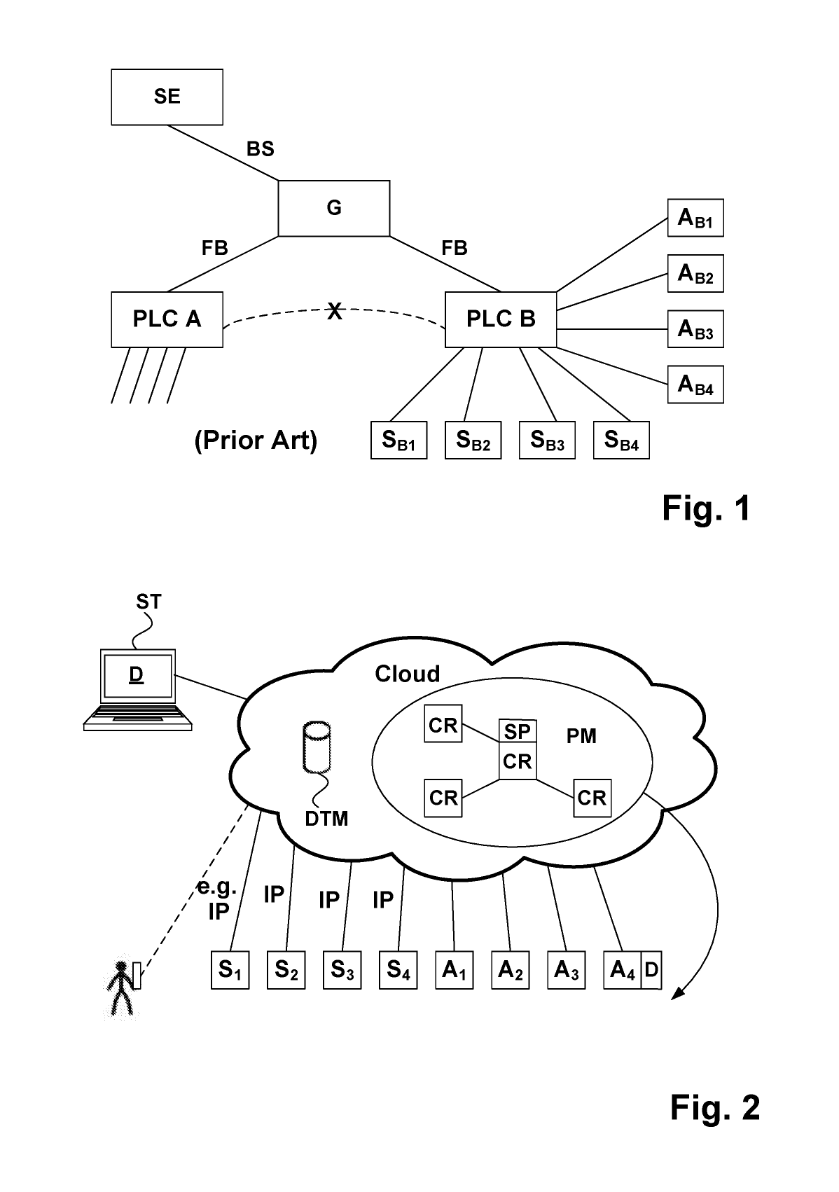

FIG. 2 a schematic representation of an embodiment of the system of the invention for operating an automated plant,

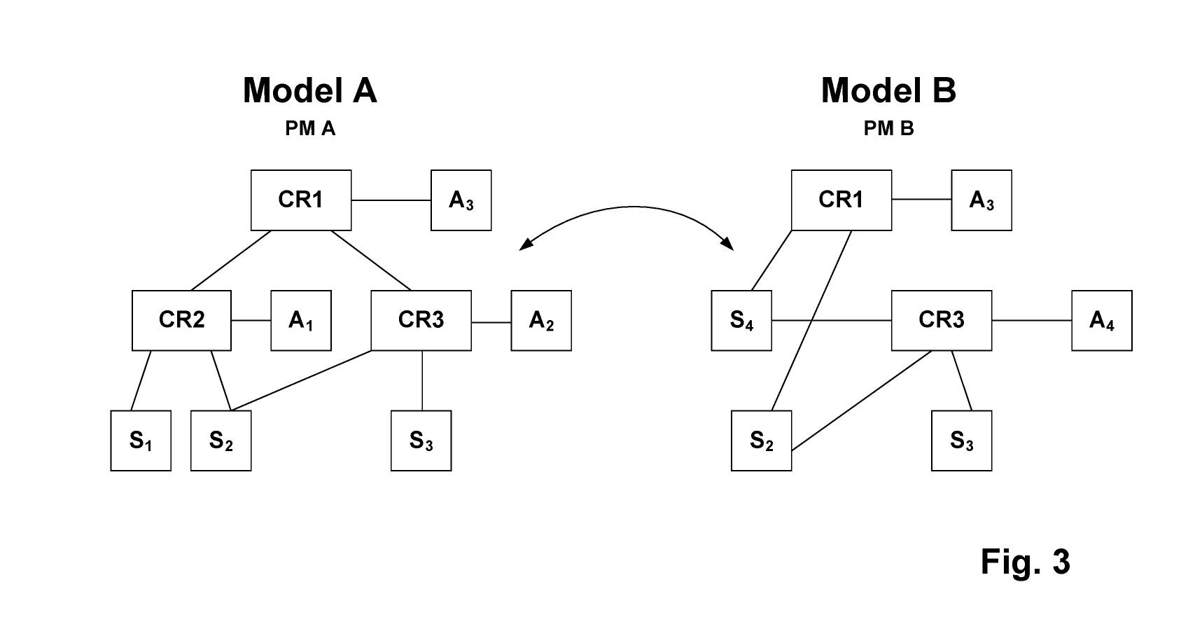

FIG. 3 a schematic representation showing how two different automated plants can be serviced via the system of the invention.

FIG. 1 shows a schematic representation of a system known from the state of the art for operating an automated plant. The automated plant serves, as already mentioned above, for example, for the manufacture of a product, the bottling of a medium, the control of a clarification plant, etc.

Known systems for operating an automated plant are structured strongly hierarchically. Usually, arranged on the field plane, depending on size of the plant are a plurality of controllers PLC A, PLC B. Communication between the controllers PLC A, PLC B and the above greater detailed, process near, field devices A, S, which are coupled to one of the controllers PLC A, PLC B, occurs via at least one of the fieldbusses FB customary in automation technology. Direct communication between the individual controllers PLC A, PLC B is excluded or at least only limitedly possible.

At the control plane, the controllers PLC A, PLC B deliver their data collected from the field devices A, S and/or further processed, measured values to a superordinated control unit, e.g. a SCADA. Usually applied at the control plane is a high speed bus BS, e.g. an industrial Ethernet, for communication purposes. Conversion between the different bus systems BS, FB occurs via a gateway G. Due to the fixedly predetermined connecting line- and communication paths, known systems are not very flexible. Changes in the plant structure can only be reacted to—when at all—with much effort. Usually, the system must be completely newly set up.

FIG. 2 shows a schematic representation of an embodiment of the system of the invention for operating an automated plant. The automated plant is not detailed in FIG. 2. It can, however, such as indicated above, be any industrial plant. The monitoring and/or control of the plant occurs also here via various field devices A, S. In the illustrated case, these are actuators A and sensors S. The field devices A, S serve for determining and/or monitoring physical or chemical, process variables. Sensors for process automation are manufactured and sold by the applicant in the most varied of embodiments.

Furthermore, the system for flexibly operating the automated plant includes a plurality of computers CR. These are located in the cloud and communicate via the Internet or an operator internal intranet with one another and with the field devices A, S. The number of computers CR depends on the scope of the calculational effort and control operations predetermined and to be performed via the at least one plant model PM and also on the desired processing speed. Both the computers CR as well as also the field devices A, S must be embodied network capably. They are connected, respectively connectable, with one another via a network—thus wireless or wired Internet or an intranet. A unique address in the network is associated, respectively associable, with each computer CR and each field device A, S. If the communication occurs via a defined network protocol, for example, TCP-IP, then an IP address is associated with each component of the network.

Further associated with the network capable computers CR is at least one plant model PM. The plant model PM is a virtual map, thus a software map, of the system for operating the respective automated plant, and describes the plant topology, the plant function and the interaction of the field devices S, A with one another and with the computers CR, in given cases, as a function of time. The plant model PM is so embodied that it is adapatable flexibly to different plant topologies, different plant functions and/or different interaction of the field devices A, S with one another and with the computers CR. The computers CR control the automated plant via the particular plant model PM corresponding to current plant topology, current plant function and/or current interaction of the field devices A, S with one another and with the at least one computer CR. Field devices A, S coupled to the cloud can either automatically cyclically transmit the data, respectively measured values, generated by them or deliver such via a classical request/reply communication via polling by the computers of the cloud to the computers. Often in this connection, this is also referred to as cloud computing, respectively computing in the cloud. Cloud computing refers to the approach of providing, via a network, abstract IT infrastructures, such as hardware, computing capacity, data memory, network capacities or also software dynamically adapted according to need. Use of the offered services occurs exclusively via defined interfaces and protocols. Major parts of the IT infrastructure are in the case of cloud computing no longer kept on-site by the plant operator, but, instead, they are leased, respectively provided, by the plant operator from a service provider providing the IT infrastructure in the cloud. Of course, operator and service provider can be identical. Changes to the respective plant model can be effected via an operating, or servicing, tool ST.

The system of the invention enables, when required, flexible switching between different plant models PM A, PM B. This opportunity of alternating between two different plant models PM A, PM B is shown in FIG. 3. In the case of the Model A—PM A—three computers CR1, CR2, CR3 are required. For operating the automated plant, three sensors S1, S2, S3 and three actuators A1, A2, A3 are required. Computer CR1 in the shown case is currently connected, respectively connectable, with the computers CR2, CR3 and with the actuator A3. If one of these two computers CR2, CR3 fails, then the computer CR3 can directly take over their work, since the plant model is also accessible to the computer CR3. Furthermore, the computer CR3 can, when required, function as a redundant, in given cases, also diverse computer.

The computer CR2 is connected with the actuator A1 and the two sensors S1, S2. Computer CR3 is likewise connected to the sensor S2 (again, here redundancy is present), the sensor S3 and the actuator A2.

The plant model PM B differs from the plant model PM A. In the case of plant model PM B, two computers CR1, CR3 are required for operating the automated plant. The computer CR1 is connected with the sensor S2 and the additional sensor S4, as well as with the actuator A3. Computer CR3 in plant model PM B is connected with the sensors S2, S3, S4 and the additional actuator A4. Either there is here, in turn, redundancy and/or diversity relative to the sensors S2 and S4, or, however, individual modules of the software for operating the plant are stored in each computer. For example, computer CR1 could further process the raw data of the sensor S4 and condition such to measured values, while computer CR3 executes a diagnosis of the sensor S4. Or, the two computers CR1, CR3 can condition the raw data and compare the results with one another for the purpose of verification. The opportunities for application have no limits. Especially, reference is made to the options, which have already been explained above in connection with the invention.

1-20. (canceled)

21. A system for flexible operation of an automated plant, comprising:
at least one computer; and
a plurality of field devices for determining and/or monitoring physical or chemical, process variables, wherein:
said at least one computer and the field devices are embodied to be network capable and are connected, respectively connectable, with one another via a network;
a unique address in the network is associated, respectively associable, with each computer and each field device and wherein communication occurs via a defined network protocol;
associated with said network capable computer, respectively the network capable computers, is at least one plant model, which virtually maps plant topology, plant function and interaction of said field devices with one another and with said at least one computer;
said plant model is so embodied that it is adapatable flexibly to different plant topologies, different plant functions and/or different interaction of said field devices with one another and with said at least one computer; and
said at least one computer controls via said plant model the automated plant corresponding to current plant topology, current plant function and/or current interaction of said field devices with one another and with said at least one computer.

22. The system as claimed in claim 21, wherein:
a plurality of computers are provided, which are embodied redundantly and/or diversely, said computers work redundantly or in combination with one another.

23. The system as claimed in claim 21, wherein:
for the case, in which the automated plant is running a production process, in which said at least one computer so controls the production rate by adapting current plant functions and/or current interaction of said field devices with one another and with said at least one computer that energy consumption of the automated plant is optimized.

24. The system as claimed in claim 21, wherein:
for the case, in which the automated plant is running a production process, in which said at least one computer so controls production process that yield of the produced products is maximum and/or that the amount of occurring waste products is minimum.

25. The system as claimed in claim 21, wherein:
said at least one computer detects, based on diagnostic data of said field devices malfunctions and/or predictable or actual loss of defective field devices and transfers the plant function of a malfunctioning or lost field device to at least one field device, which is able to perform the plant function of the malfunctioning or lost field device.

26. The system as claimed in claim 21, further comprising:
a display on said field device or on a service tool, via which said field device is maintained, especially adjusted, calibrated or verified; and
a mobile service tool, which maintains, especially adjusts, calibrates or verifies said field device via said at least one computer.

27. The system as claimed in claim 23, wherein:
said at least one computer during the course of production performs a verification phase; and
information concerning verified course of production is stored in at least one memory unit associated with said computer.

28. The system as claimed in claim 21, wherein:
associated with said network capable computer, respectively said network capable computers are a plurality of plant models, which virtually map plant topology, plant function and interaction of said field devices with one another and with the at least one computer for different automated plants and/or production processes; and
said computer, respectively said computers, so controls/control the production plant that a selected plant model is used and the corresponding production process can run in the automated plant.

29. The system as claimed in claim 21, further comprising:
field device-specific or field device type-specific drivers, wherein said at least one computer so parameters said field devices via said drivers that they are applicable in the production process and/or in the automated plant corresponding to the selected plant model.

30. The system as claimed in claim 21, further comprising:
electronics associated with each of the field devices, wherein:
said electronics is embodied either as a minimum electronics, which provides raw data of said field devices, or said electronics is embodied as an evaluating electronics and provides conditioned and/or evaluated data.

31. The system as claimed in claim 21, further comprising:
a coupler, which is so embodied that a field device with an analog current output is network capable.

32. The system as claimed in claim 30, wherein:
for the case, in which said electronics is a minimum electronics, said at least one computer performs conditioning and/or evaluation of the provided data.

33. The system as claimed in claim 30, wherein:
for the case, in which said electronics is an evaluating electronics, said field device transmits raw data available in said field device and conditioned and/or evaluated data to said at least one computer, said computer conditions and/or evaluates the raw data and compares the provided conditioned and/or evaluated data with the data conditioned and/or evaluated by said computer.

34. The system as claimed in claim 21, wherein:
firmware and/or device drivers of the individual field devices are/is associated with said at least one computer.

35. The system as claimed in claim 21, further comprising:
firmware and/or device drivers of the individual field devices in at least two different versions, a first version and a successor version, are/is associated with the at least one computer; wherein:
said at least one computer replaces the first version during operation of the automated plant with the successor version, as soon as the successor version works faultlessly.

36. The system as claimed in claim 21, wherein:
said plant model, respectively said plant models, is/are constructed modularly; and
in the case of a plurality of computers said modularly embodied plant model, respectively said plant models, are divided among said computers.

37. The system as claimed in claim 21, wherein:
said plant model, respectively said plant models, is/are developed on a test system and tested with virtual field device models; and
said developed plant model is copied, respectively is transmitted, to at least one analog, automated plant after the test phase.

38. The system as claimed in claim 21, wherein:
a tested plant model, respectively tested plant models, of an automated plant are copied, respectively transmitted, to identical automated plants.

39. The system as claimed in claim 21, wherein:
the system is integrated into an internal company network, or for the case, in which communication is at least partially via an external, freely accessible network, at least one VPN tunnel structure is provided for the communication.

40. The system as claimed in claim 21, wherein:
there is integrated at least in a part of said field devices a web server, via which servicing of said field devices occurs via said computers or via a mobile operating, or servicing, tool.
